(19) United States
(12) Patent Application Publication
(10) Pub. No.: US 2014/0360666 A1
(43) Pub. Date: Dec. 11, 2014

(54) METHOD AND DEVICE FOR BONDING OF SUBSTRATES

(71) Applicant: Jürgen Burggraf, Scharding (AT)

(72) Inventor: Jürgen Burggraf, Scharding (AT)

(73) Assignee: EV Group E. Thallner GmbH

(21) Appl. No.: 14/368,827

(22) PCT Filed: Dec. 28, 2011
(86) PCT No.: PCT/EP2011/074166

§ 371 Date: Jun. 26, 2014

(51) Int. Cl. B32B 38/18; B32B 37/00

(52) U.S. Cl. CPC B32B 38/18; B32B 37/187
USPC 156/299; 156/556

(57) ABSTRACT

A device and method for bonding first substrates to second substrates. The device includes: a receptacle for accommodating a carrier substrate, a placement device for placing multiple first substrates on a substrate side of the carrier substrate that faces away from the receptacle, and a fixing device for fixing each of the first substrates on the substrate side on at least one fixing section of each first substrate. The method includes the following steps: placement of multiple first substrates on a substrate side of a carrier substrate accommodated on a receptacle, and fixing of each first substrate on the substrate side on at least one fixing section of each first substrate.

The present invention pertains to a device for bonding of first substrates to second substrates according to claim 1, as well as a corresponding method according to claim 7.

The production of wafer stacks (stacks) from at least two substrates is done on bonding systems with high acquisition costs; the bonding process involves, among other things, high temperatures and is frequently time-consuming. Accordingly, in semiconductor process engineering there exists the problem of low throughput, correspondingly high costs per unit, and high energy consumption. This problem arises to a greater extent for applications in which very small substrates need to be processed. From today's point of view, substrates with a diameter <=6″, especially <=4″ and in extreme cases <=2″ can be viewed as small.

The object of this invention is therefore to present a device and a method for bonding and pre-fixing of substrates with which it is possible to have a higher throughput, lower costs per unit, and energy savings in the bonding of the substrates.

This object is achieved with the features of claims 1 and 7. Advantageous developments to the invention are indicated in the dependent claims. The invention also covers all combinations of at least two features indicated in the specification, the claims, and/or the figures. With regard to the value ranges indicated, values lying within the specified boundaries are intended to be disclosed as boundary values and to be claimable in any combination.

This invention is founded on the basic idea of, especially using a standard bonding chamber, bonding multiple substrate stacks that are arranged next to each other on a carrier substrate and that consist of at least a first and a second substrate, in parallel and at the same time.

As an independent invention a device for bonding first substrates to second substrates is therefore provided, with the following features:
receptacle to receive one or especially multiple carrier substrate(s),
a placement device to place multiple first substrates on the substrate side of the carrier substrate that faces away from the receptacle, and
a fixing device for fixing each of the first substrates on the substrate side on at least one fixing section of each first substrate

As an independent invention, a method is also provided for bonding first substrates to second substrates with the following steps, especially with the following sequence:
Placement of multiple first substrates on a substrate side of a carrier substrate accommodated in a receptacle and
Fixing of each of the first substrates on the substrate side on at least one fixing section of each first substrate.

Because of the aforementioned pre-fixing of multiple substrate stacks (stacks), consisting in each case of at least a first substrate and a second substrate, whereof in each case multiple substrate stacks are arranged distributed on the substrate side, it becomes possible to bond multiple substrate stacks at the same time. The fixing or pre-fixing thus serves first and foremost to transport the carrier substrate produced according to the invention, in particular to a separate bonding chamber.

According to an advantageous embodiment of the invention, it is provided that the fixing device is set up for the temporary fixing of each first substrate and that the first substrates are temporarily fixed on the substrate side. The temporary fixing is also known as “tacking”, where, for the temporary fixing, polymers, adhesives, or the formation of eutectic alloys are available according to the invention. Alternatively, Van-der-Waals bonds between two polished surfaces can be used. Such bonds are known in the state of the art and are often produced and used, for example between silicon oxide surfaces. The temporary fixing is done in particular in such a way that the fixing is so strong that the carrier substrate with the substrate stacks temporarily fixed thereon can be transported without the substrates placed on the carrier substrates slipping or falling off.

Advantageously, before they are placed, the first substrates are aligned on alignment marks where, as regards hardware, a placement device (or a separate placement device) is set up for aligning and placing the first substrates on alignment marks. In this way the placement of additional (respectively second or optionally more, i.e., third, fourth, etc.) substrates on the first substrate is accelerated.

Correspondingly, according to another advantageous embodiment of the invention, it is provided that the second substrates, especially after the first substrates are aligned on alignment marks, are placed on the first substrates and/or are fixed thereon, particularly temporarily. To accomplish this, in terms of hardware, the placement device and/or a separate placement device is provided for the placement of multiple second substrates on the first substrates, particularly aligned on alignment marks. Because alignment marks are provided, it is possible to ensure efficient and exact positioning of the respective substrates relative to one another, especially when the fixing device is set up for fixing, especially for temporarily fixing, each second substrate placed on a first substrate.

In an especially advantageous embodiment of the invention, it is provided that in each case the second substrates are bonded simultaneously to the first substrates, especially permanently bonded, in particular in a bonding chamber designed as a separate bonding module. Thus, the above-described pre-fixing is decoupled from the time-consuming bonding step, so that a higher throughput is possible, whereby at the same time energy savings are realized by providing a bonding chamber that is used for bonding only.

To the extent that hardware features have been described, they are also to be regarded as disclosed as process-related features.

Other advantages, features, and particulars of the invention are shown in the following figure description. The figures show, respectively, in a schematic representation:

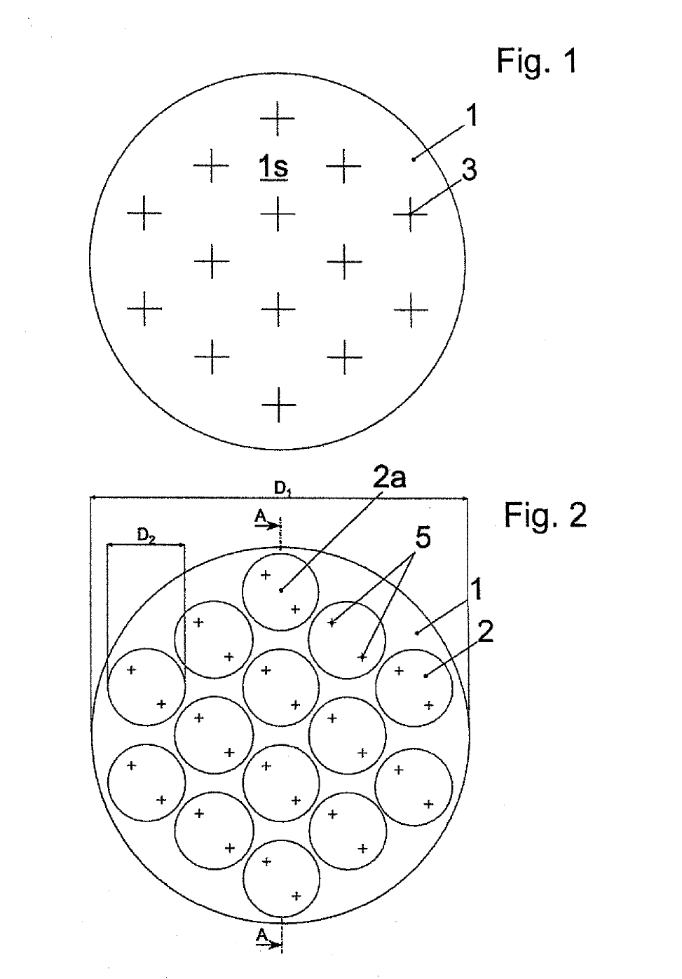

FIG. 1 shows a top view of a carrier substrate in a first process step according to the invention,

FIG. 2 shows a top view of the carrier substrate with placed first substrates according to a second process step according to the invention and a section line A-A,

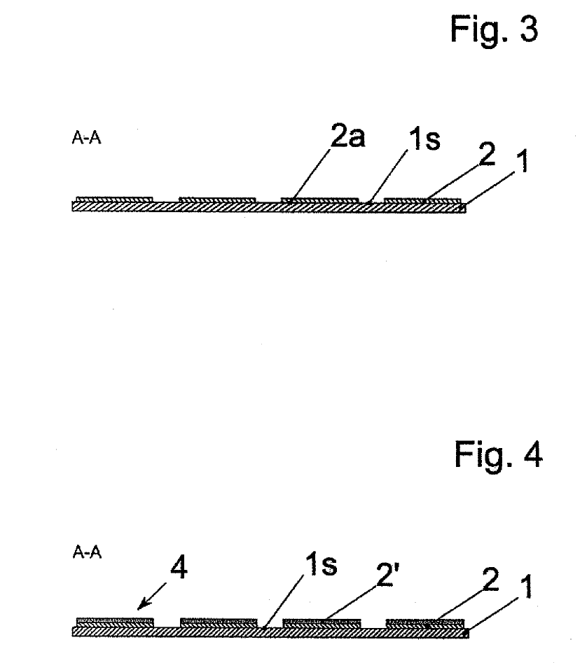

FIG. 3 shows a cross-sectional view along section line A-A from FIG. 2, and

FIG. 4 shows a cross-sectional view along section line A-A from FIG. 2 after second substrates are placed on the first substrates.

In the figures the advantages and features of the invention are marked with the identifying references according to embodiments of the invention, where components and features with the same or equivalent functions are identified with identical references.

According to FIG. 1, on a carrier wafer 1 with a diameter D₁ multiple alignment marks 3 are provided, distributed, especially evenly, on a substrate side 1s of the carrier wafer. The alignment marks 3 can be picked up by a placement device for placing multiple first substrates 2 on the substrate side 1s in such a way that in each case the first substrates 2 can be placed on the carrier substrate 1 at a alignment mark 3 (see FIG. 2).

The first substrates 2 have a diameter D₂, which is especially less than half of the diameter D₁, preferably less than one third of the diameter D₁, and even more preferably less than one quarter of the diameter D₁. Thus, first substrates 2 in the embodiment shown 14 can be deposited and temporarily fixed on the substrate side 1s.

In an alternative embodiment the carrier substrates have essentially the same diameter as the first substrates. In particular, the diameter of the first substrates differs from that of the carrier substrates by less than 50%, or better by less than 25%, advantageously by less than 15%, or most advantageously by less than 5%. In this embodiment the receptacle for the carrier substrates is designed in such a way that it can receive and fix multiple carrier substrates at the same time. Suitable fixing means are known to one skilled in the art. For example, vacuum fixing can be applied. All other features and process steps behave similarly to the examplary embodiment with only one single carrier substrate with a diameter that is larger than that of the first substrates. In particular, one or more pass marks for aligning the first substrates are provided on the individual carrier substrates on the side 1s facing away from the receptacle.

The temporary fixing is done in each case in at least one fixing section 2a of each first substrate 2, i.e., at at least one, especially point-shaped, fixing place. In an embodiment with stronger fixing force, the fixing of each first substrate 2 is done on two or three fixing sections 2a, where in the case of a single fixing section 2a the fixing section 2a is located in the center of each first substrate 2 (see the embodiment according to FIG. 2).

In cross-section through the first substrates 2 (see FIG. 3), the first substrates 2 of each row of first substrates 2 are arranged distributed on the first substrate side 1s, especially equidistant from one another.

In the process step shown in FIG. 4, second substrates 2′ are placed on first substrates 2, especially individually in each case, where for placement alignment marks 5 are provided on the first substrates 2. In particular, every first substrate 2 has at least two alignment marks 5 so that there can be not only a translationally correct alignment of the first substrate 2 with the second substrates 2′, but also a rotationally correct alignment.

After the second substrates 2′ are placed and aligned on the first substrates 2, a number of substrate stacks 4 (in the examplary embodiment shown, 14 substrate stacks 4) consisting of in each case first substrates 2 and the second substrate 2′ are pre-fixed on the carrier substrate 1 in such a way that the carrier substrate 1 can be transported with the substrate stacks 4 to a bonding chamber, not shown, where the substrate stacks 4 are permanently bonded simultaneously.

According to the invention, it is conceivable, on an embodiment not shown, in each case to stack additional substrates on top of the second substrates 2′ and to fix them temporarily in each case so that substrate stacks with more than two substrates are created.

In doing so, according to the invention, alignment accuracies in aligning the first and the second substrates 2, 2′, as well as in aligning multiple substrates, of especially less than 100 μm, preferably of less than 50 μm, even more preferably of less than 10 μm and more preferably yet of less than 2 μm, can be achieved.

During the bonding process in the bonding chamber, the temporary bond is dissolved, in particular automatically by the permanent bonding, preferably by temperature exposure. To the extent that polymers and/or adhesives have been used for the temporary bonding, they are dissolved into gas during the bonding, especially without any residue.

For the pre-fixing and/or the bonding, a so-called flip-chip-bonder is preferably used.

In an advantageous embodiment of the invention, the carrier substrate 1 consists of a material with a thermal expansion coefficient that does not deviate by more than 5% from the thermal expansion coefficient of the first and/or second substrates 2, 2′, especially if it is made of the same material. For example, glass wafers or silicon wafers can be used as carrier substrate 1 and/or as first/second substrate 2, 2′.

### REFERENCE NUMBER LIST

1 carrier substrate
1s substrate side
2 first substrate
2a fixing section
2′ second substrate
3 alignment marks
4 substrate stack
5 alignment marks
D1 diameter
D2 diameter

1. A device for bonding of first substrates to second substrates with the following features:
a receptacle for accommodating at least one carrier substrate,
a placement device for placing multiple first substrates on a substrate side of the carrier substrate that faces away from the receptacle, and
a fixing device for fixing each of the first substrates on the substrate side on at least one fixing section of each first substrate,
wherein the placement device respectively places one or more second substrates on one or more first substrates and the fixing device fixes each of the one or more second substrates respectively placed on the one or more first substrates.

2. The device according to claim 1, wherein the fixing device is set up for temporarily fixing each of the first substrates.

3. The device according to claim 1, wherein the placement device aligns and places the first substrates on alignment marks.

4. The device according to claim 1, wherein the placement device places multiple second substrates on each of the one or more first substrates, said multiple second substrates aligned on alignment marks of the one or more first substrates when placed thereon.

5. The device according to claim 4, wherein the fixing device temporarily fixes each second substrate placed on the one or more first substrates.

6. The device according to claim 4, wherein the device further comprises a bonding chamber, for simultaneous bonding of the first and second substrates.

7. A method for simultaneous bonding of first substrates to second substrates, said method comprising:
placing multiple first substrates on a substrate side of a carrier substrate that is accommodated on a receptacle;
fixing of each of the first substrates on the substrate side on at least one fixing section of every first substrate; and
placing and fixing the second substrates on the first substrates.

8. A method according to claim 7, wherein the multiple first substrates are temporarily fixed on the substrate side.

9. The method according to claim 7, wherein the multiple first substrates are aligned on alignment marks before placing the multiple first substrates on the substrate side of the carrier substrate that faces away from the receptacle.

10. The method according to claim 7, wherein the second substrates are placed and/or temporarily fixed on the first substrates.

11. The method according to claim 10, wherein the second substrates are in each case simultaneously bonded to the first substrates.

12. The device according to claim 6, wherein the bonding chamber is provided as a separate bonding module.

13. The device according to claim 6, wherein the first and second substrates are permanently bonded.

14. The method according to claim 10, wherein the second substrates are placed and/or temporarily fixed on the first substrates after being aligned on alignment marks of the first substrates.

15. The method according to claim 11, wherein the second substrates are permanently bonded to the first substrates.

16. The method according to claim 11, wherein the second substrates are in each case simultaneously bonded to the first substrates in a bonding chamber designed as a separate bonding module.
